(19) United States
(12) Patent Application Publication
(10) Pub. No.: US 2007/0202292 A1
(43) Pub. Date: Aug. 30, 2007

(54) Elastically deformable protection element for movable scaffolds or platforms

(76) Inventor: Marcel Johannes Van Der Roest, Lelystad (NL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/592,798

(22) PCT Filed: Mar. 23, 2005
(86) PCT No.: PCT/NL05/00217

§ 371 Date: Sep. 14, 2006

(30) Foreign Application Priority Data
Apr. 29, 2004 (NL) 1026077

(51) Int. Cl. B62M 1/00; B32B 3/02

(52) U.S. Cl. 428/66.6; 428/99

(57) ABSTRACT

An impact-resistant protection element, which can be fitted around legs of mobile scaffolds. The protection element, which is generally disc-shaped, is made of a material capable of at least manual elastic deformation, such as a plastic. An engagement opening present in the material is made accessible by deformation of the material, so that the protection element can readily be brought into engagement with the legs of the scaffold. The protection element includes one or more recesses that provide space upon deformation of the material, which recesses prevent the formation of cracks in the material in the case of frequent use. The protection element prevents damage being caused when the scaffold is moved towards a newly finished wall. The protection element will bump against the wall in that case, and impact forces will be absorbed under elastic deformation thereof without damage being caused.

The present invention relates to an impact-resistant protection element made of a material capable of at least manual elastic deformation, which comprises an engagement opening extending through the material, which is accessible to an object upon deformation.

The invention furthermore relates to a protection system comprising:
a protection element having a material capable of at least manual elastic deformation, which comprises an engagement opening that is accessible to an object through deformation; and
the object with which the protection element has been brought into engagement via the engagement opening, wherein the protection element is configured in such a manner that at least part thereof extends beyond the contours of the object, which may or may not project locally.

Such a protection element is known from JP-11-342848 A. The known protection element is made of an impact-resistant, elastically deformable material such as polyurethane, Styrofoam, or a natural or a synthetic rubber. The element may be disc-shaped and be provided with an engagement opening in the centre thereof. A cut extends towards the engagement opening, so that material parts that are to be pulled apart are formed in a possible embodiment, as a result of which the engagement opening becomes accessible to an object, such as a leg of a handcart, upon deformation of the material. The material parts, once they are fitted round the leg, can be coupled together.

The object of the present invention is to provide an improved protection element and a corresponding protection system which provides protection, and continues to provide protection, in practical situations against damage caused by the object and which remains effective also after frequent use.

In order to accomplish that object, the protection element and the protection system according to the invention are characterized in that the protection element is provided with one or more recesses that provide space upon deformation of the material.

The advantage of the protection element according to the invention is that the formation of cracks upon regular manual deformation of the impact-resistant, flexible material from which it is made is prevented, in particular in those places in the material where additional mechanical loads are exerted when the usually two halves are manually moved apart and spring back elastically again. Furthermore, the material of the protection element will less easily be damaged when the two halves are pulled too far apart, since the recesses provide space for the material upon deformation of said material.

Another advantageous aspect of the protection element suitable for frequent use is the fact that when the object actually hits a wall, for example, the material thereof will deform elastically and no wall fragments will come off and the wall will not be dented or smudged. During construction, completion, renovation or reconstruction of a hall or room, movable or mobile scaffolds, such as scaffolds on wheels for indoor use, collapsible scaffolds, stepladders or working platforms frequently bump against newly finished walls or against doorjambs, causing damage thereto. In that case the plasterer or the carpenter, and in most case also the painter, must return to the construction project at a later stage to repair the damage; and that often several times in a row, to repair damage caused at different places and different times, which, in the case of projects with a high finishing level, leads to correspondingly high unanticipated additional costs.

Damage of this kind can be effectively eliminated in that inexpensive protection elements suitable for frequent use are manually fitted and subsequently removed again in a simple manner.

Furthermore, the protection element may be characterized in that the material is a light-weight and/or inflatable, if desired, material.

It is preferred, however, to use a plastic material which can be made to measure in sufficient numbers and shapes in a simple and quick manner, for example a laminated plastic—which is built up of layers—or a cross-linked plastic, which, if the material is suitably selected, is sufficiently strong yet flexible, durable, wear resistant, dense and dimensionally stable.

The protection element and the associated protection system according to the present invention will now be explained in more detail with reference to the figures below, in which like parts are indicated by the same numerals. In the figures:

FIG. 1 shows a first possible preferred embodiment of a protection element according to the invention;

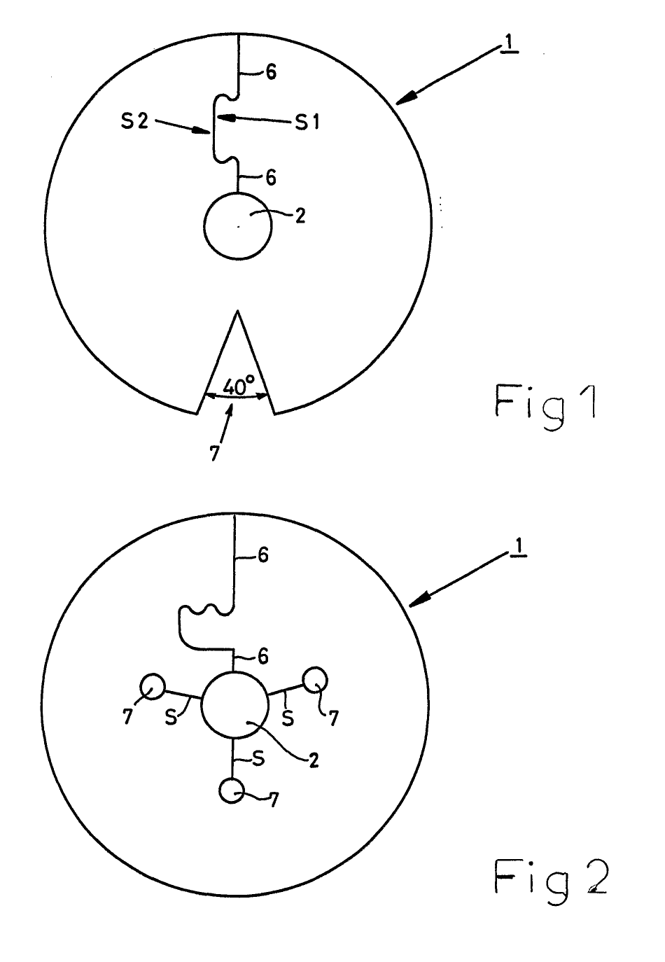

FIG. 2 shows a second possible preferred embodiment of a protection element according to the invention;

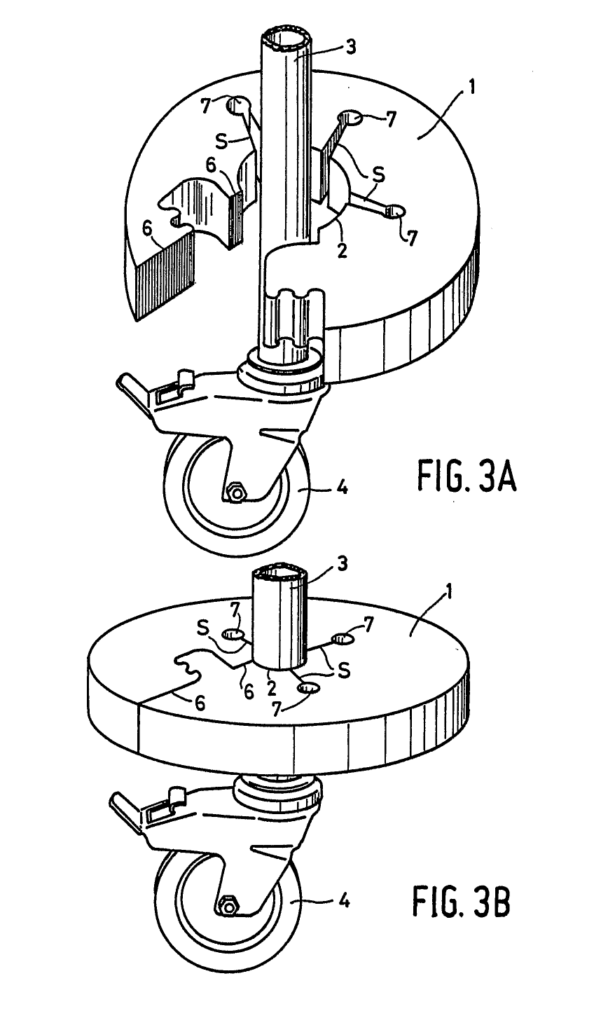

FIGS. 3A and 3B show a manner in which the protection element of FIG. 2 is fitted and has been fitted, respectively, round a post of a movable scaffold;

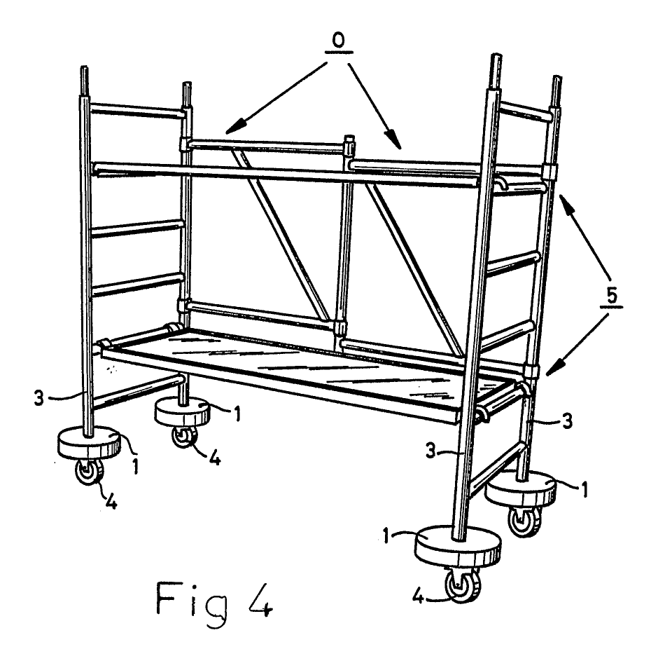

FIG. 4 shows an example of a protection system according to the invention that has been formed therewith.

FIGS. 1 and 2 each show a protection element 1, which is made of an impact-resistant, preferably light-weight material that is capable of manual elastic deformation. Examples of such suitable materials are to be found among the common or less common plastic or foam plastic materials. Such materials may be laminated, for example, in which case they are composed of several layers, which has a positive effect on the resistance to wear of said materials. Other examples are plastics comprising cross-linked chains, as a result of which a high degree of dimensional stability is obtained, which is retained for a prolonged period of time. Examples of such materials are: PEC-3404, LD-24 and PEE-2502. Preferred materials are materials which are dimensionally stable and elastic and which do not dent more than about 1 cm and regain their shape upon being subjected to an impact force such as the impact forces that occur in practice. The material must be capable of manual deformation, so that an engagement opening 2, which extends entirely or partially through the material, can readily be brought into engagement with a part of an object O. Said part may be a post 3 of the object O, as shown in FIGS. 3A and 3B. The object O may be a scaffold, a platform or the like, which in many cases can be moved, for example on wheels 4. Said wheels 4 or other projecting parts of the object O can easily come into contact with a wall or a column and cause damage thereto, which damage needs to be repaired at additional cost at a later stage.

FIG. 4 shows a protection system 5 in the form of a scaffold O, which is provided with protection elements 1 at four positions, in this case at the lower end of the posts 3.

In the embodiments of FIGS. 1 and 2 the protection elements 1 are each provided with an engagement opening 2, which extends substantially centrally through the protection element 1. In the figures a substantially disc-shaped element 1 is shown by way of non-limitative example. In those cases in which the engagement opening 2 is not located at the circumference of the element 1, a cut 6 is provided, which cut extends between the engagement opening 2 and the outer circumference of the protection element 1. Said cut 6 divides the element 1 into cut halves S1 and S2—two in this case—which are held together. It is conceivable to use separate interlocking elements, but this will increase the cost price and consequently it has been elected to configure each cut half S1 and S2 with manually detachable interlocking shapes, such as dovetail shapes, although may other shapes that hold the cut halves S1 and S2 together may be selected. By manually moving the two cut halves S1 and S2 apart in axial and/or tangential direction, the engagement opening 2 is pulled open and made accessible to the post 3 of the object O (in this case).

To make it easier to open the engagement opening 2 and to prevent cracks being formed in the material after frequent use or when the material is pulled open too far, recesses 7, in this case in the form of wedge-shaped openings and/or holes, are provided at predefined positions in the embodiments of FIGS. 1 and 2, so that the recesses provide space for the material upon deformation of the material. Cuts S extending from the holes 7 towards the engagement opening 2 may be provided so as to make it possible to pull the cut halves S1 and S2 even further apart without damaging the element 1.

Many variants to the embodiments as described above or, for example, combined forms of the elements of FIGS. 1 and 2 are conceivable. The type of material, the place of fitting, the dimensions and the shape of the protection element 1 may be changed, of course, and be adapted to specific requirements that are usually dictated by the practical applications. The element 1 may be capable of rotation round the object O, as has become apparent in the foregoing, but is not necessary. According to another possibility, only part of the protection element 1 extends beyond the contours of the object O, which may or may not project locally. The element 1 might be inflatable, if desired, although it needs to be pumped up in that case, and/or contain a rubber insofar as said rubber does not leave any smears on the walls. Shaping the material into its desired form can take place in a known manner, for example by sawing, cutting or die-cutting.

1-9. (canceled)

10. An impact-resistant protection element made of a material capable of at least manual elastic deformation, comprising:
an engagement opening extending through the material, which is accessible to an object upon deformation; and
one or more recesses that provide space upon deformation of the material.

11. A protection element according to claim 10, wherein the engagement opening extends substantially centrally through the protection element.

12. A protection element according to claim 10, wherein the protection element is substantially disc-shaped.

13. A protection element according to claim 10, wherein at least part of the protection element extends beyond contours of the object.

14. A protection element according to claim 10, wherein the material is a light-weight and/or inflatable material.

15. A protection element according to claim 14, wherein the material is a plastic material, or a laminated or a cross-linked plastic.

16. A protection element according to claim 10, wherein the protection element encloses the engagement opening, and the material includes a cut with adjoining cut halves, which extends between the engagement opening and an outer circumference of the protection element.

17. A protection element according to claim 16, wherein the cut halves are configured with locking shapes that can be manually fitted together and be detached again.

18. A protection system, comprising:
the protection element according to claim 10, including a material capable of at least manual elastic deformation, and which comprises an engagement opening that is accessible to an object through deformation; and
the object with which the protection element has been brought into engagement via the engagement opening, wherein the protection element is configured such that at least part thereof extends beyond contours of the object, which may or may not project locally,
wherein the protection element includes one or more recesses that provide space upon deformation of the material.
